(19) United States
(12) Patent Application Publication
(10) Pub. No.: US 2010/0259182 A1
(43) Pub. Date: Oct. 14, 2010

(54) LIGHT SOURCE INTENSITY CONTROL SYSTEM AND METHOD

(75) Inventors: Kwong MAN, Vancouver (CA); Ian ASHDOWN, West Vancouver (CA)

Correspondence Address: Philips Intellectual Property and Standards, P.O. Box 3001, Briarcliff Manor, NY, 10510-8001, US

(73) Assignee: TIR TECHNOLOGY LP, Burnaby, BC (CA)

(21) Appl. No.: 12/161,812

(22) PCT Filed: Feb. 9, 2007
(86) PCT No.: PCT/CA07/00188

§ 371 Date: Jul. 23, 2008

Related U.S. Application Data
(60) Provisional application No. 60/772,458, filed on Feb. 10, 2006.
(60) Provisional application No. 60/830,196, filed on Jul. 11, 2006.

(30) Foreign Application Priority Data
Jul. 18, 2006 (CA) 2552685

(51) Int. Cl. H05B 37/02

(52) U.S. Cl. 315/250; 315/297

(57) ABSTRACT

The light source comprises one or more first light-emitting elements for generating light having a first wavelength range and one or more second light-emitting elements for generating light having a second wavelength range. The first light-emitting elements and second light-emitting elements are responsive to separate control signals provided thereto. A control system receives a signal representative of the operating temperature from one or more sensing devices and determines first and second control signals based on the desired colour of light and the operating temperature. The light emitted by the first and second light-emitting elements as a result of the received first and second control signals can be blended to substantially obtain the desired colour of light. The desired colour of light generated can thus be substantially independent of junction temperature induced changes in the operating characteristics of the light-emitting elements.

### FIELD OF THE INVENTION

The present invention pertains to the field of illumination and in particular to an intensity control system for a light source.

### BACKGROUND

Recent advances in the development of semiconductor light-emitting diodes (LEDs) and organic light-emitting diodes (OLEDs) have made these devices suitable for use in general illumination applications, including architectural, entertainment, and roadway lighting, for example. As such, these devices are becoming increasingly competitive with light sources such as incandescent, fluorescent, and high-intensity discharge lamps.

Due to its natural lighting characteristics, white light is typically the preferred choice for lighting. An important consideration for LED-based luminaires used for ambient lighting and LED-based backlighting for liquid crystal displays (LCDs) is the need to produce natural white light. White light can be generated by mixing the light emitted from different colour LEDs.

Various standards have been proposed to characterize the spectral content of light. One way to characterize light emitted by a test light source is to compare it with the light radiated by a black body and identify the temperature of the black body at which its perceived colour best matches the perceived colour of the test light source. That temperature is called correlated colour temperature (CCT) and is usually measured in Kelvin (K). The higher the CCT, the bluer, or cooler the light appears. The lower the CCT, the redder, or warmer the light appears. An incandescent light bulb has a CCT of about 2856 K, and fluorescent lamps can have CCTs in the range of about 3200K to 6500 K.

Furthermore the properties of light can be characterized in terms of luminous flux and chromaticity. Luminous flux is used to define the measurable amount of light and chromaticity used to define the perceived colour impression of light, irrespective of its perceived brightness. Chromaticity and luminous flux are measured in units according to standards of the Commission Internationale de l'Eclairage (CIE). The CIE chromaticity standards define hue and saturation of light based on chromaticity coordinates that specify a position in a chromaticity diagram. The chromaticity coordinates of light are derived from tristimulus values and expressed by the ratio of the tristimulus values to their sum; i.e. x=X/(X+Y+Z), y=Y/(X+Y+Z), z=Z/(X+Y+Z), where x, y and z are the chromaticity coordinates and X, Y, and Z are the tristimulus values. Because x+y+z=1, it is only necessary to specify two chromaticity coordinates such as x and y, for example. Any CCT value can be transformed into corresponding chromaticity coordinates.

In spite of their success, LED-based light sources can be affected by a number of parameters in a complex way. Chromaticity and luminous flux output of LEDs can greatly depend on junction temperature, which can have undesirable effects on the CCT and more generally the chromaticity of the emitted light.

Ignoring temperature dependencies, the amount of light emitted by an LED is proportional to its instantaneous forward current. If the LEDs are pulsed at a rate greater than about 60 Hz, the human visual system perceives a time-averaged amount of light as opposed to individual pulses. As a result, light source dimming can be achieved by varying the amount of time-averaged forward current, using such techniques as pulse width modulation (PWM) or pulse code modulation (PCM). However, changes in the average forward current can affect the junction temperature of the LED, which can alter the spectral power distribution and in consequence the CCT or chromaticity and luminous flux of the light emitted by the LED. The compensation of this effect can become complex when various coloured LEDs are used to generate mixed light of a desired chromaticity. As discussed by M. Dyble, in “Impact of Dimming White LEDs: Chromaticity Shifts Due to Different Dimming Methods,” Fifth International Conference on Solid State Lighting, Bellingham, Wash.; SPIE Vol. 5941, 2005, colour appearance of the resultant mixed light can shift unacceptably when dimming, as the spectral power distribution of the individual LEDs can change.

LED junction temperature variations can also cause undesired effects in the spectral power distribution of the resultant output light. Variations in junction temperature not only can reduce the luminous flux output, but can also cause undesirable variations in the CCT of the mixed light. Furthermore, overheating of LEDs can also reduce the life span of LEDs.

In order to overcome these limitations, various methods for generating natural white light have been proposed. U.S. Pat. No. 6,448,550 to Nishimura teaches a solid-state illumination device having a plurality of LEDs of different colours and use optical feedback. Light from the LEDs is measured by photosensitive sensors mounted in close proximity with LEDs and compared with a reference set of responses to a previously measured spectral power distribution. The amount of variation between the sensor responses to the light from the LEDs and the previously measured spectral power distribution is used as a basis for adjusting the current to the LEDs in order to maintain the light from the LEDs as close as possible to the pre-determined spectral power distribution. While the Nishimura reference provides a way to achieve control of the spectral power distribution of the output light with a desired colour property, it uses a complex optical feedback system.

U.S. Pat. No. 6,507,159 to Muthu discloses a control method and system for an LED-based luminaire having a plurality of red, green and blue light LEDs for generating a desired light by colour mixing. Muthu seeks to alleviate the unwanted variations in the luminous flux output and CCT of the desired light by providing a control system with a feedback system including filtered photodiodes, a mathematical transformation for determining tristimulus values of the LEDs, and a reference-tracking controller for resolving the difference between the feedback tristimulus values and the desired reference tristimulus values in order to adjust the forward current of the LEDs, such that the difference in tristimulus values is reduced to zero. The calculations as required by Muthu for the mathematical transformations can, however, make it difficult to implement an optical feedback control system with a response time that is fast enough to avoid visual flicker during dimming operations, for example.

U.S. Pat. No. 6,576,881 to Muthu et al. discloses a method and system for controlling the output light generated by red, green, and blue LEDs. Sensors positioned proximate to the LEDs to detect a first set of approximate tristimulus values of the output light. The first set of tristimulus values is communicated to a controller, which converts these values into a second set of tristimulus values representative of a standard colourimetric system. The relative luminous flux output of the LEDs is adjusted on the basis of the difference between the second set of the tristimulus values and a set of user-specified tristimulus values. Based on this configuration, as with some previously identified prior art, the calculations required for the mathematical transformations can make it difficult to implement an optical feedback control system with a response time that is fast enough to avoid visual flicker during dimming operations, for example.

U.S. Pat. No. 6,630,801 to Schuurmans provides a method and system for sensing the colour point of resultant light produced by mixing coloured light from a plurality of LEDs in the RGB colours. The system comprises a feedback unit for generating feedback values corresponding to the chromaticity of the resultant light based on values obtained from filtered and unfiltered photodiodes that are responsive to the light from the LEDs. The system also comprises a controller which adjusts the resultant light based upon the difference between the feedback values and values representative of the chromaticity of a desired resultant light. While the Schuurmans reference provides a way to achieve control of the spectral power distribution of the output light with a desired colour property, it also uses a complex optical feedback system.

U.S. Patent Publication No. 2003/0230991 to Muthu et al. discloses an LED-based white-light backlighting system for electronic displays. The backlighting system of Muthu et al. includes a plurality of LEDs of different light colours arranged such that the combination of light colours produces white light. The system also comprises a microprocessor which monitors the luminous flux, radiant flux, or tristimulus levels of the white light and controls the luminous flux and chromaticity of the white light by feedback control. The backlighting system of Muthu et al. uses photodiodes with filters to determine approximate tristimulus values of the LEDs and adjusts the luminous flux and chromaticity of the white light. While the Muthu et al. reference provides a way to achieve control of the spectral power distribution of the output light with a desired colour property, it uses a complex optical feedback system.

U.S. Pat. No. 6,441,558 also to Muthu et al. discloses a multi-colour LED-based luminaire for generating light at different colour temperatures. The desired luminous flux output for each array of colour LEDs is achieved by using a controller system that adjusts the current supplied to the LEDs based on the chromaticity of the desired light and the junction temperature of the LEDs. One of the shortcomings associated with the LED-based luminaire of Muthu et al. is that in order to measure the luminous flux of an array of LEDs, an optical feedback sensor is used to obtain the luminous flux from the LEDs which is communicated to the controller by a polling sequence. According to Muthu et al., the measurement sequence begins by measuring the luminous flux output of the all LED arrays in operation. Each array of LEDs is alternately switched “OFF” briefly, and a further measurement is taken. The difference between the initial measurement and the next measurement provides the light output from the LED array that was turned OFF. The measurement of the light output is repeated for the remaining LED arrays. Again, while the Muthu et al. reference provides a way to achieve control of the spectral power distribution of the output light with a desired colour property, it uses a complex optical feedback system. In addition, a drawback of this procedure as disclosed by Muthu et al. is the excessive amount of thermal stress imposed on the LEDs during ON and OFF cycles at low frequencies which are required for the optical feedback system.

Therefore, there is a need for a relatively simple light source intensity control system and method that can account for device junction temperature effects on the light emitted by the light source.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a light source intensity control system and method. In accordance with an aspect of the present invention, there is provided a light source for generating a desired colour of light, said light source comprising: one or more first light-emitting elements for generating first light having a first wavelength range, the one or more first light-emitting elements responsive to a first control signal; one or more second light-emitting elements for generating second light having a second wavelength range, the one or more second light-emitting elements responsive to a second control signal; one or more sensing devices for generating one or more signals representative of operating temperatures of the one or more first light-emitting elements and the one or more second light-emitting elements; and a control system operatively coupled to the one or more first light-emitting elements, the one or more second light-emitting elements and the one or more sensing devices, the control system configured to receive the one or more signals and configured to determine the first control signal and the second control signal based upon the operating temperatures and the desired colour of light; wherein the first light and the second light are blended to create the desired colour of light.

In accordance with another aspect of the present invention there is provided a method for generating a desired colour of light, the method comprising the steps of: determining a first operating temperature of one or more first light-emitting elements which provide first light having a first spectrum; determining a second operating temperature of one or more second light-emitting elements which provide second light having a second spectrum; providing a first spectral radiant intensity model indicative of effects of the first operating temperature on the first spectrum; providing a second spectral radiant intensity model indicative of effects of the second operating temperature on the second spectrum; determining a first control signal and a second control signal based upon the first spectral radiant intensity model, the second spectral radiant intensity model, the desired colour of light and the first operating temperature and second operating temperature; providing the first control signal to the one or more first light-emitting elements; providing the second control signal to the one or more second light-emitting elements; and blending the first light and the second light into mixed light having the desired colour of light.

### BRIEF DESCRIPTION OF THE FIGURES

FIG. 1 illustrates a light source according to one embodiment of the present invention.

FIG. 2 illustrates both the measured spectral radiant intensity and double Gaussian modelled spectral radiant intensity of a blue light-emitting diode according to one embodiment of the present invention.

FIG. 3 illustrates the temperature dependent variations of the parameters for a double Gaussian model of the spectral radiant intensity of a red light-emitting diode according to one embodiment of the present invention.

FIG. 4 illustrates the temperature dependent variations of the parameters for a double Gaussian model of the spectral radiant intensity of an amber light-emitting diode according to one embodiment of the present invention.

FIG. 5 illustrates the colour gamut for the three coloured light-emitting elements as defined by the CIE 1931 x,y Chromaticity Diagram.

### DETAILED DESCRIPTION OF THE INVENTION

### Definitions

The term “light-emitting element” (LEE) is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic or quasi-monochromatic spectral emission characteristics. Examples of light-emitting elements include semiconductor, organic, or polymer/polymeric light-emitting diodes, blue or UV pumped phosphor coated light-emitting diodes, optically pumped nanocrystal light-emitting diodes or any other similar devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “luminous flux” is used to define the amount of light emitted by a light source according to standards of the Commission Internationale de l'Eclairage (CIE). Where the wavelength regime of interest includes infrared and/or ultraviolet wavelengths, the term “luminous flux” is used to include radiant flux as defined by CIE standards.

The term “chromaticity” is used to define the perceived colour impression of light according to CIE standards.

The term “intensity” is used to define the measured photometric brightness of a light source according to the standards of the Commission Internationale de l'Eclairage (CIE).

The term “spectral radiant intensity” is used to define the radiant intensity of light at a given wavelength emitted by a light source according to the standards of the CIE.

The term “emission spectrum” is used to define the distribution of spectral radiant intensity of all wavelengths of visible light.

The term “controller” is used to define a computing device or microcontroller having a central processing unit (CPU) and peripheral input/output devices (such as A/D or D/A converters) to monitor parameters from peripheral devices that are operatively coupled to the controller. These input/output devices can also permit the CPU to communicate and control peripheral devices that are operatively coupled to the controller. The controller can optionally include one or more storage media collectively referred to herein as “memory”. The memory can be volatile and non-volatile computer memory such as RAM, PROM, EPROM, and EEPROM, floppy disks, compact disks, optical disks, magnetic tape, or the like, wherein control programs (such as software, microcode or firmware) for monitoring or controlling the devices coupled to the controller are stored and executed by the CPU. Optionally, the controller also provides the means of converting user-specified operating conditions into control signals to control the peripheral devices coupled to the controller. The controller can receive user-specified commands by way of a user interface, for example, a keyboard, a touchpad, a touch screen, a console, a visual, acoustic input device, or other device as is well known to those skilled in this art.

As used herein, the term “about” refers to a +/−10% variation from the nominal value. It is to be understood that such a variation is always included in any given value provided herein, whether or not it is specifically identified.

Unless defined otherwise, all technical and scientific terms used herein have the same meaning as commonly understood by one of ordinary skill in the art to which this invention belongs.

The present invention provides a light source for generating a desired colour of light. The light source comprises one or more first light-emitting elements for generating light having a first wavelength range and one or more second light-emitting elements for generating light having a second wavelength range. The first light-emitting elements and second light-emitting elements are responsive to separate control signals provided thereto. The light source further includes a sensing device for sensing operating temperature or temperatures of the first and second light-emitting elements. A control system receives a signal representative of the operating temperature(s) from the sensing device and determines the first and second control signals based on the desired colour of light and the operating temperatures. The light emitted by the first and second light-emitting elements as a result of the received first and second control signals can be blended to substantially obtain the desired colour of light. In this manner, the desired colour of light generated by the light source can be substantially independent of junction temperature induced changes in the operational characteristics of the light-emitting elements.

In another embodiment, the light source can additionally comprise one or more third light-emitting element for generating light having a third wavelength range, one or more fourth light-emitting elements for generating light having a fourth wavelength, etc, as would be readily understood by a worker skilled in the art. In this embodiment, the sensing device may be configured to sense the operating temperature of the one or more third light-emitting elements, one or more fourth light-emitting elements etc, which would be received by the control system enabling subsequent determination of control signals for these third and fourth light-emitting elements.

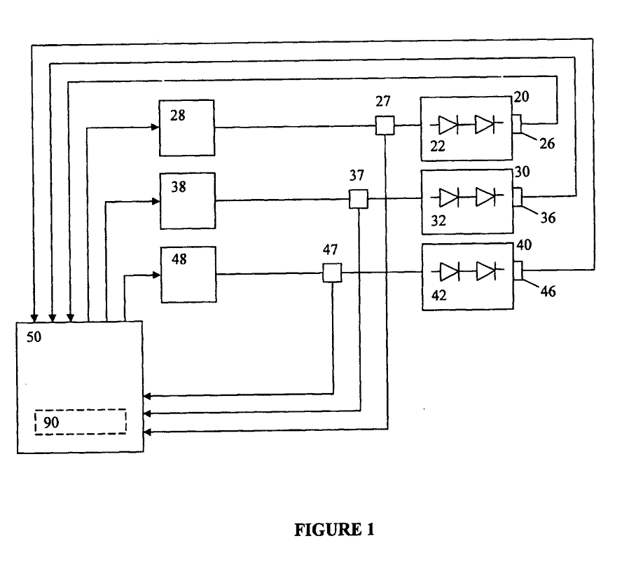

FIG. 1 illustrates a block diagram of a light-emitting element light source according to one embodiment of the present invention. The light source includes arrays 20, 30, 40 each having one or more light-emitting elements that are in thermal contact with one or more heat sinks or heat extraction mechanisms (not shown). The combination of coloured light generated by each of the red light-emitting elements 22, green light-emitting elements 32 and blue light-emitting elements 42 can generate light of a specific chromaticity, for instance white light. In one embodiment, the light source includes mixing optics (not shown) to spatially homogenize the output light generated by mixing light from the red light-emitting elements 22, green light-emitting elements 32, and blue light-emitting elements 42.

Current drivers 28, 38, 48 are coupled to arrays 20, 30, 40, respectively, and are configured to supply current to the red light-emitting elements 22, green light-emitting elements 32, and blue light-emitting elements 42 in arrays 20, 30, 40. The current drivers 28, 38, 48 control the luminous flux outputs of the red light-emitting elements 22, green light-emitting elements 32, and blue light-emitting elements 42 by regulating the flow of current through the red light-emitting elements 22, green light-emitting elements 32, and blue light-emitting elements 42. The current drivers 28, 38, 48 are configured to regulate the supply of current to arrays 20, 30, 40 interdependently so as to control the chromaticity of the combined light as described hereinafter.

A controller 50 is coupled to current drivers 28, 38, 48. The controller 50 is configured to interdependently adjust the amount of average forward current by adjusting the duty factor of the current drivers 28, 38, 48, thereby providing control of the luminous flux output of the red light-emitting elements 22, green light-emitting elements 32, and blue light-emitting elements 42.

In one embodiment of the present invention, a temperature sensor 26, 36 or 46 is in thermal contact with all arrays 20, 30 and 40 and coupled to controller 50, thereby providing a means for measuring the operating temperature of the arrays 20, 30, 40. The operating temperature of the arrays 20, 30, 40 can be correlated to the junction temperature of red light-emitting elements 22, green light-emitting elements 32 and blue light-emitting elements 42. In one embodiment, each array 20, 30 and 40 has a separate temperature sensor 26, 36 and 46 respectively, in order to measure each array's individual operating temperature.

In one embodiment of the present invention, alternately, or in combination with one or more temperature sensors, voltage sensors 27, 37, 47 are coupled to the output of current drivers 28, 38, 48 and measure the instantaneous forward voltage of light-emitting element arrays 20, 30, 40. Controller 50 is coupled to voltage sensors 27, 37, 47 and configured to monitor the instantaneous forward voltage of light-emitting element arrays 20, 30, 40. The forward voltage of the arrays 20, 30, 40 can be correlated to the junction temperature of red light-emitting elements 22, green light-emitting elements 32 and blue light-emitting elements 42. For example, experimentally derived correlations between junction temperature and LED peak wavelength, spectral width or output power are disclosed by Chhajed, S. et al., 2005, “Influence of Junction Temperature on Chromaticity and Colour-Rendering Properties of Trichormatic White-Light Sources Based on Light-Emitting Diodes”, Journal of Applied Physics 97, 054506, herein incorporated by reference.

The controller 50, based on the detected temperatures and/or detected forward voltages can determine the junction temperature of each of the red light-emitting elements 22, green light-emitting elements 32 and blue light-emitting elements 42 and based on a predetermined model of temperature dependence to spectral output of each of the red light-emitting elements 22, green light-emitting elements 32 and blue light-emitting elements 42, together with the desired colour of light to be created, the controller can determine control signals for the control of the operation of the red light-emitting elements 22, green light-emitting elements 32 and blue light-emitting elements 42, in order that the desired colour of light is generated by the light source.

### Light-Emitting Elements

The light-emitting elements can be selected to provide a predetermined colour of light. The number, type and colour of the light-emitting elements within the light source can provide a means for achieving high luminous efficiency, a high Colour Rendering Index (CRI), and a large colour gamut. The light-emitting elements can be manufactured using either organic material, for example OLEDs or PLEDs or inorganic material, for example semiconductor LEDs or other device configurations as would be readily understood by a worker skilled in the art. The light-emitting elements can be primary light-emitting elements that can emit colours including blue, green, red or can emit another colour or colours. The light-emitting elements can optionally be secondary light-emitting elements, which convert the emission of a primary source into one or more monochromatic wavelengths or quasi-monochromatic wavelengths. Additionally, a combination of primary and/or secondary light-emitting elements can be employed. As would be readily understood by a worker skilled in the art, the one or more light-emitting elements can be mounted for example on a PCB (printed circuit board), a MCPCB (metal core PCB), a metallized ceramic substrate or a dielectrically coated metal substrate, or the like, that carries traces and connection pads. The light-emitting elements can be in unpackaged form such as in a die format or may be packaged parts such as LED packages or may be packaged with other components including for example drive circuitry, optics and control circuitry.

In one embodiment, an array of light-emitting elements having spectral outputs centred around wavelengths corresponding to the colours red, green and blue can be selected, for example. Optionally, light-emitting elements of other spectral output can additionally be incorporated into the light source, for example light-emitting elements radiating at the red, green, blue and amber wavelength regions may be configured as arrays or optionally may include one or more light-emitting elements radiating at the cyan wavelength region, or other wavelength region as would be readily understood by a worker skilled in the art. The selection of light-emitting elements can be directly related to the desired colour gamut and/or the desired maximum luminous flux and colour rendering index to be created by the lighting module.

In one embodiment, multiple light-emitting elements can be connected electrically in a plurality of configurations. For example, the light-emitting elements can be connected in series or parallel configurations or combinations of both. In one embodiment of the present invention, two or more light-emitting elements are connected in series as strings, wherein a string may comprise light-emitting elements of the same colour bin.

In another embodiment of the present invention, light-emitting elements are electrically connected in order that each individual light-emitting element can be individually controlled. For example, a string of light-emitting elements can be wired such that some light-emitting elements can be bypassed either partially, or completely to allow this individual control of each light-emitting element independent of one another.

### Sensing Device

In one embodiment of the present invention, a temperature sensor is configured to measure the junction temperature of the light-emitting elements in the arrays, wherein the single temperature sensor is strategically positioned to detect the operating temperature of all colours of light-emitting elements. For example, in one embodiment, the light-emitting elements can be mounted on a common thermally conductive substrate upon which the temperature sensor is mounted.

In an alternate embodiment, separate temperature sensors can be configured to measure the temperature of each colour of light-emitting element individually. In this manner a more accurate measure of the junction temperature of each colour of light-emitting element colour can be determined. In this embodiment, a temperature sensor can be positioned proximate to the appropriate colour of light-emitting elements. The different colours of light-emitting elements can be thermally isolated from each other or may be mounted on a common substrate or heat sink.

In accordance with one embodiment of the invention, the temperature sensor can be a thermistor, thermopile, thermocouple, integrated temperature sensing circuits, a silicon based sensor or other temperature sensing device as would be known to a worker skilled in the art, that is configured to measure the temperature of the desired light-emitting element(s).

In another embodiment, the junction temperature of the light-emitting elements is calculated based on the detected forward voltage drop across the light-emitting elements. The forward voltage drop across a light-emitting element varies substantially linearly with temperature. The forward drop across a string of light-emitting elements can thus be measured and the variation in forward voltage drop can be employed to approximately determine the instantaneous junction temperature of the light-emitting element(s).

In another embodiment, the junction temperature of the light-emitting elements can be determined using both the evaluated voltage drop across the light-emitting elements and the temperature detected by one or more temperature sensors.

In one embodiment, the sampling of data detected by a temperature sensor and/or a voltage sensor can be performed at a predetermined interval, after a predetermined operating time, continuously or randomly.

In one embodiment, the sampling rate can be adjusted during operation of the light source. The adjustment of the sampling can be dependent on for example the duty cycle of operation of a light-emitting element, a particular colour of light-emitting element or an evaluated average duty factor for all or some of the light-emitting elements in the light source.

### Control System

The control system receives the temperature data from the sensing device in a format dependent on the sensing device. The control system subsequently manipulates this temperature data in order to evaluate the junction temperature of the light-emitting elements. Subsequently the control system is configured to model the emission spectrum of each light-emitting element or colour of light-emitting element, as a function of temperature. In this manner temperature modified spectral output characteristics of the light-emitting elements can be determined.

The controller is further configured to evaluate control signals for transmission to the light emitting elements. These control signals are determined based on the desired colour of light to be generated by the light source and the temperature modified spectral output characteristics of the light-emitting elements in the light source.

In one embodiment of the present invention, the spectral radiant intensity, I(λ) of a light-emitting element, for example a semiconductor light-emitting diode, can be modeled using a double Gaussian approximation defined as follows:

$$I ( λ ) = {\hat{I}}_{1} {e}^{- 4 l n ( 2 ) {( \frac{λ - {\hat{λ}}_{1}}{{Δλ}_{1}} )}^{2}} + {\hat{I}}_{2} {e}^{- 4 l n ( 2 ) {( \frac{λ - {\hat{λ}}_{2}}{{Δλ}_{2}} )}^{2}} \qquad ( 1 )$$

where Î₁ and Î₂ are peak spectral radiant intensities, \hat{λ}₁ and \hat{λ}₂ are peak spectral radiant intensity wavelengths, Δλ₁ and Δλ₂ are spectral full width half maximum (FWHM) bandwidths and λ is the wavelength.

It would be readily understood by a worker skilled in the art that one or more of the parameters of the right hand side of Equation (1) can, for practical purposes of an application of an embodiment of the present invention, depend on further operating parameters including operating temperature T or age of the light-emitting element, for example, even when this is not explicitly indicated. It is therefore understood that, for example, Î₁, Î₂, \hat{λ}₂, Δλ₁ and Δλ₂ are merely abbreviations which can always include further parametric dependencies, for example a temperature dependence which can be explicitly expressed as Î(T), if such a dependency is relevant for practical purposes.

Furthermore, it would be readily understood by a worker skilled in the art that an another function other than that described in Equation (1) and possibly with other parameters, can be used to approximate, with its own accuracy, the spectral radiant intensity I(λ) of a light-emitting element relative to the operating temperature thereof.

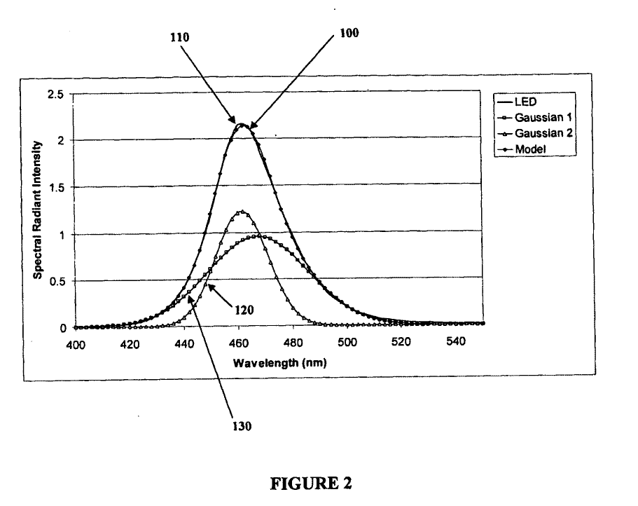

In one embodiment of the present invention, an example of a double Gaussian approximation of the spectral radiant intensity of a blue light-emitting diode is illustrated in FIG. 2. In this example the modeled approximation 100, is substantially equal to the observed spectral radiant intensity 110 of the blue light-emitting diode being tested. In this embodiment, the modeled approximation 100 is the sum of a first Gaussian function 130 and a second Gaussian function 120. Each of the two Gaussian functions can be defined by parameters relating to relative peak spectral radiant intensity, peak spectral radiant intensity wavelength and spectral FWHM bandwidth, which correspond to the height, centre position and width of the Gaussian function, respectively.

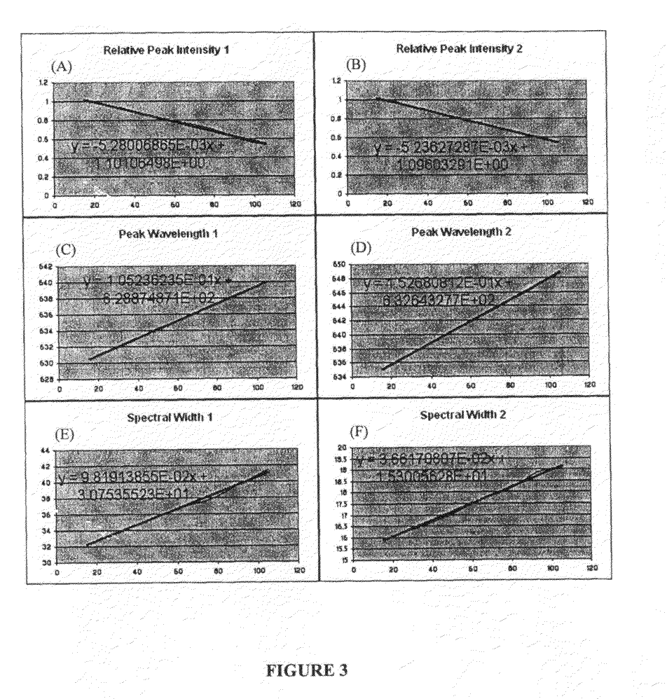

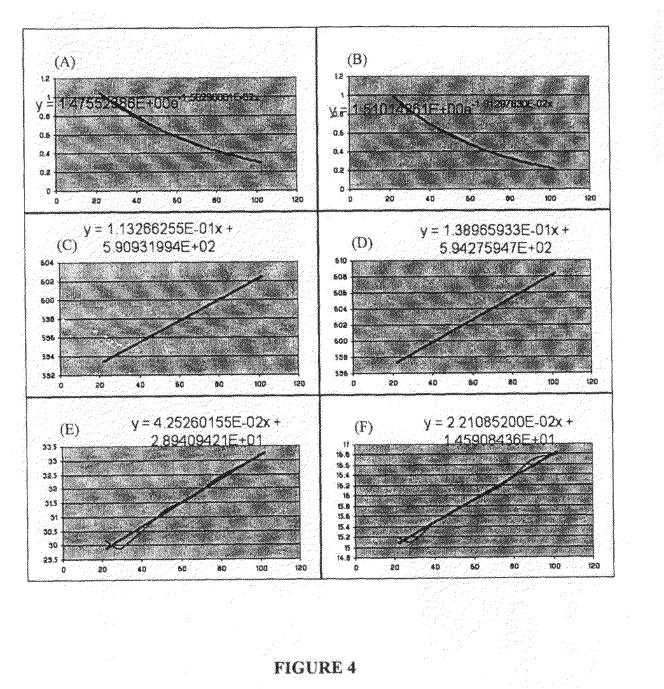

In one embodiment, the parameters of each Gaussian function can be experimentally evaluated for its temperature dependence thereby providing a means for determining a modeled temperature-modified spectral radiant intensity for a light-emitting element. FIGS. 3 and 4 illustrate the temperature dependence of the parameters for each Gaussian function used to generate a temperature-modified model for spectral radiant intensity of a particular red light-emitting diode and a particular amber light-emitting diode, respectively. The temperature dependence of the peak spectral radiant intensities for the first Gaussian function and the second Gaussian function are illustrated in FIGS. 3A, 4A and FIGS. 3B, 4B, respectively. The temperature dependence of the peak spectral radiant intensity wavelengths for the first Gaussian function and the second Gaussian function are illustrated in FIGS. 3C, 4C and FIGS. 3D, 4D, respectively. Finally, the temperature dependence of the spectral full width half maximum bandwidths for the first Gaussian function and the second Gaussian function are illustrated in FIGS. 3E, 4E and FIGS. 3F, 4F, respectively. In one embodiment, the parameters can be defined as being either linearly dependent or exponentially dependent on junction temperature of the light-emitting element.

In one embodiment of the present invention, the emission spectrum of a light-emitting element is measured in a certain setup with a defined reference light-emitting element operating temperature, for example 25° C. junction temperature. The double Gaussian approximation can then be curve-fitted to the emission spectrum using a known, robust minimization algorithm for solving for example a least squares or a least distance error function, thereby determining the peak spectral radiant intensity at T=25° C. described as Îₙ(25), the peak spectral radiant intensity wavelength at T=25° C. λₙ(25), and spectral FWHM bandwidth at T=25° C. Δλₙ(25) with n∈{1,2}. In an embodiment wherein a linear approximation is practically effective, each peak intensity Îₙ for n∈{1,2} at temperature T can be defined as a first order approximation in T which can be defined as follows:

Îₙ(T)=aₙT+bₙ (2)

wherein parameters aₙ and bₙ can be determined experimentally by curve fitting experimental data obtained from measuring the emission spectrum over a range of different operating temperatures. For example, as is illustrated in FIG. 3, the spectrum of some red AlInGaP light-emitting diodes, for example, can be satisfactorily approximated using a linear approximation of Îₙ (T) as defined in Equation (2).

In an embodiment wherein a linear approximation is practically ineffective, an exponential temperature dependency can be used and can be defined as follows:

Îₙ(T)=cₙexp(−dₙT) (3)

wherein parameters cₙ and dₙ can be determined experimentally by curve fitting experimental data obtained from measuring the emission spectrum over a range of different operating temperatures. For example, as is illustrated in FIG. 4 the exponential approximation as defined in Equation (3) can be useful in describing Îₙ(T) for certain AlInGaP light-emitting diodes.

Similarly, in one embodiment of the present invention, the peak wavelength for each n∈{1,2} at temperature T can be defined as follows:

\hat{λ}ₙ(T)=eₙT+fₙ (4)

wherein parameters eₙ and fₙ can be determined experimentally by measuring the emission spectrum over a range of temperatures and curve fitting. For example, for the red AlInGaP light-emitting diode illustrated in FIG. 3, \hat{λ}ₙ(T) can be approximated using Equation (4). In other embodiments, exponential or other non-linear approximations may be utilized to effectively describe the temperature dependence of the peak wavelength.

Similarly, in one embodiment of the present invention, the spectral FWHM for each n∈{1,2} at temperature T can be defined as follows:

Δλₙ(T)=gₙT+hₙ (5)

wherein parameters gₙ and hₙ can be determined experimentally by measuring the emission spectrum over a range of temperatures and curve fitting. For example, for the red AlInGaP light-emitting diode illustrated in FIG. 3, \hat{λ}ₙ(T) can be approximated using Equation (5). In other embodiments, exponential or other non-linear approximations may be utilized to effectively describe the temperature dependence of the spectral FWHM.

Example empirically-derived thermal model parameters according to an embodiment of the present invention and Equations (2) and (3) respectively, as well as Equations (4) and (5) at T=25° C. reference temperature for the linear approximations are provided in Table 1 for arbitrary units (a.u.) in intensity. It is noted that fₙ and hₙ for n∈{1,2} are not specified in Table 1.

TABLE 1
LED thermal model coefficients

| Parameter | Red | Amber | Green | Blue |
|---|---|---|---|---|
| a₁ [a.u./° C.] or d₁ [1/° C.] | −0.0052 | 0.0155 | −0.0034 | −0.0048 |
| a₂ [a.u./° C.] or d₂ [1/° C.] | −0.0058 | 0.0190 | −0.0048 | −0.0035 |
| [a.u./° C.] | | | | |
| b₁ or c₁ [a.u.] | 1.1295 | 1.4747 | 1.0856 | 1.1191 |
| b₂ or c₂ [a.u.] | 1.1462 | 1.6066 | 1.1207 | 1.0881 |
| e₁ [nm/° C.] | 0.1107 | 0.1120 | 0.0000 | 0.0226 |
| e₂ [nm/° C.] | 0.1526 | 0.1387 | 0.0445 | 0.0504 |
| g₁ [nm/° C.] | 0.0831 | 0.0428 | 0.1051 | 0.1081 |
| g₂ [nm/° C.] | 0.0327 | 0.0209 | 0.0562 | 0.0903 |

In an embodiment of the present invention, the control system can be configured with a model which can adequately represent the thermal coupling, for example thermal transfer, between light-emitting elements in a light-emitting element cluster. Such a model can be used to determine, in a feed-forward manner, the mutual heating effects which can occur when light-emitting elements are mounted, for example, on a common substrate.

In one embodiment of the present invention, the heat Q dissipated by a light-emitting element is approximately equal to its power consumption which can be defined as follows:

Q≈V_{F}ID (6)

wherein V_{F} is the light-emitting element forward voltage, I is the drive current, and D is the PWM duty factor. The difference ΔTₛ₋ⱼ between the temperature of the light-emitting element package slug and the temperature of the light-emitting element junction can be defined as follows:

ΔTₛ₋ⱼ=QRΘₛ₋ⱼ (7)

wherein RΘₛ₋ⱼ is the thermal resistance of the light-emitting element for a specific packaging and mounting configuration. The light-emitting element junction temperature Tⱼ can be defined as follows:

Tⱼ=Tₛ+ΔTₛ₋ⱼ (8)

wherein Tₛ is the measured reference temperature, for example a light-emitting element slug temperature.

In one embodiment of the present invention, the values of the thermal resistances which are required to adequately model the characteristics of a light-emitting element can be determined in a calibration process. For example an embodiment of the present invention can comprise N PWM driven LEDs and a temperature sensor which are all in thermal contact with a printed circuit board (PCB). The PCB temperature T_{b} as provided by the temperature sensor and the temperature Tₛₙ of LED slug n can be defined as follows:

$${T}_{sn} = {T}_{b} + Δ {T}_{bn} {D}_{n} ( 1 - \frac{{k}_{n}}{3} ( {\sum }_{j = 1}^{N} {D}_{j} - {D}_{n} ) ) \qquad ( 9 )$$

wherein ΔT_{bn} is the temperature difference between the PCB board and the n^{th} LED slug, Dₙ is the duty factor of the n^{th} LED PWM drive signal, and kₙ is the load ratio for the n^{th} LED. For illustrative purposes, example values of ΔT_{bn} and kₙ, which were obtained through curve-fitting of experimental data obtained in relation to a specific embodiment of the present invention, are provided in Table 2.

TABLE 2
System thermal model coefficients

| Parameter | Red | Amber | Green | Blue |
|---|---|---|---|---|
| ΔT_{bn} [° C.] | 6.60 | 9.80 | 11.20 | 13.30 |
| kₙ | 0.45 | 0.35 | 0.35 | 0.35 |

In one embodiment of the present invention, for some PWM driven light-emitting elements, the intensity of the emitted light can linearly depend on the PWM duty factor. This relation may be used in conjunction with the spectral radiant intensity, the junction temperature and, if desired, one or more desired tristimulus coordinate transformations, to enable the control system to determine the duty factors necessary for driving the light-emitting elements.

In another embodiment, for some light-emitting elements, the duty factor and the intensity of the emitted light can correlate in a nonlinear fashion. Nonlinearities may be due to various reasons which may include one or more of, for example, transient intensity variations or varying heat load within a duty cycle and exponential cooling and heating of a light-emitting element's junction during transients between ON and OFF portions of a PWM duty cycle. Nonlinearities may be less pronounced in some types of light-emitting elements for high duty factor conditions and may be more pronounced during low duty factor conditions. In one embodiment of the present invention, nonlinearities can be modelled using a second order equation for the intensity-duty factor relationship which can be defined as follows:

I=αD²+βD (10)

wherein I is the intensity and D is the PWM drive duty factor. Example values for the constants α and β for a specific embodiment are provided in arbitrary units in Table 3.

TABLE 3
LED intensity PWM duty factor constants

| Parameter | Red | Amber | Green | Blue |
|---|---|---|---|---|
| α | −0.04 | −0.13 | −0.01 | 0.02 |
| β | 1.04 | 1.13 | 1.01 | 0.98 |

In one embodiment of the present invention, the above defined temperature-modified spectral radiant intensity for each colour of light-emitting element can be implemented in firmware as a component of a light-emitting element control system which can utilize temperature feedback to determine control parameters such as duty factors in a feed-forward manner without requiring optical feedback. The control system can be configured to maintain a desired chromaticity within a desired range and accuracy over a range of desired operating temperatures and during dimming, without the need for monitoring emitted light or acquiring optical sensor data and optical feedback or determination or measurement of tristimulus data.

It is understood that the foregoing models describe parametric relations between spectral radiant intensity, junction temperature and duty factor in conjunction with tristimulus or other suitable colour and intensity coordinates and can be used in any embodiment of a control system which can be configured to solve the set of equations which results from these models to determine the duty factors for each of one or more LEEs or groups of LEEs as a function the desired intensity and chromaticity coordinates, for example, while only requiring feedback information of the operating conditions of the LEEs.

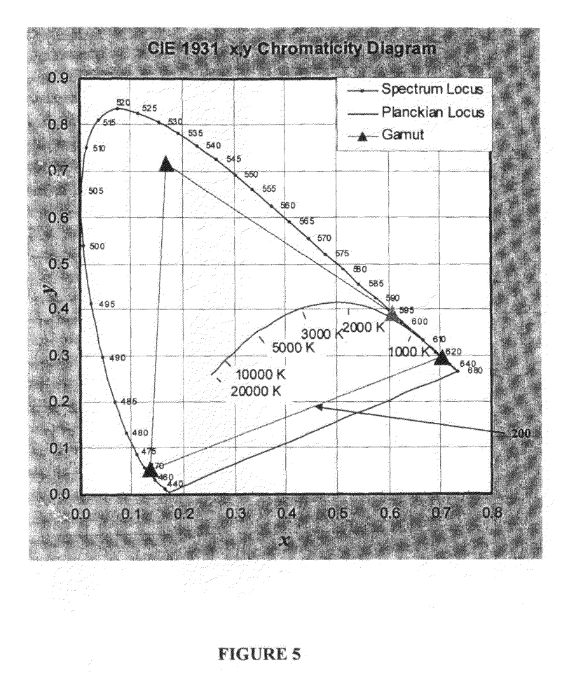

In one embodiment of the present invention, the desired colour of light can be represented by a coordinate in the CIE 1931 x,y Chromaticity Diagram as illustrated in FIG. 5. FIG. 5 further illustrates the colour gamut 200 for three coloured light-emitting elements as it would be represented by the CIE 1931 x,y Chromaticity Diagram.

Based on the particular temperature-modified spectral radiant intensity for each colour of light-emitting element and the desired colour of light, the controller can determine the desired luminous flux output for each colour of light-emitting element in order to obtain the desired colour of light. Based on this evaluated luminous flux output for each colour of light-emitting element, an appropriate control signal can be determined and transmitted to the appropriate light-emitting element(s) for controlling the luminous flux output thereof. Upon the blending of the colours of light created by the light-emitting elements, the desired colour of light can be generated.

It would be readily understood that different formats of light-emitting elements, for example based on different material compositions, which may produce a similar colour of light, can have different temperature dependencies and would therefore require temperature compensation.

In one embodiment, a controller can be associated with only a particular set of light-emitting elements. In this manner, the parameters evaluated for modeling the temperature-modified spectral radiant intensity for each of the light-emitting elements of the set, can be integrated into the controller, for example in firmware.

In another embodiment an alternate means for modeling the temperature sensitivity of the spectral radiant intensity of various colours of light-emitting elements can be integrated into the present invention. For example, a model using a combination of linear and exponential functions to generate a temperature-modified spectral radiant intensity representation for each type of light-emitting element may provide a means for reducing computational time of the control system for determination of control signals for transmission to each of the one or more light-emitting elements of the light source.

In another embodiment of the present invention, the above defined approximation and associated temperature dependencies of a set of light-emitting elements are used to synthesize training data sets for a neural network-based light-emitting element controller implemented with low-cost microcontrollers for LED intensity and chromaticity control as disclosed in U.S. Pat. No. 7,140,752 and I. Ashdown, Proceedings of Solid State Lighting III, SPIE Vol. 5187, pp. 215-226, 2003), herein incorporated by reference.

In one embodiment of the present invention the one or more current drivers can use control signals based on a pulse width modulation (PWM) technique for controlling the luminous flux outputs of the light-emitting elements. Since the average output current to the light-emitting elements is proportional to the duty factor of the PWM control signal, it is possible to dim the output light generated by the light-emitting elements by adjusting the duty factors for one or more arrays of light-emitting elements. The frequency of the PWM control signal for the light-emitting elements can be chosen such that the human eye perceives the light output as being constant rather than a series of light pulses, for example a frequency greater than about 60 Hz for example. In another embodiment, the current drivers can use control signals based on pulse code modulation (PCM), or any other digital format as known in the art.

The functionality of the invention will now be described with reference to specific testing examples. It will be understood that the following testing examples are intended to describe embodiments of the invention and are not intended to limit the invention in any way.

### EXAMPLES

A light source configured according to an embodiment of the present invention, was tested in order to evaluate the functionality of the light source. This embodiment of the light source comprised a defined LED cluster, a sensing device and a control system including a temperature-modified spectral radiant intensity model for each colour of LED. This light source was allowed to thermally stabilize at its respective full intensity and the CCT of the emitted light was set at 3000 Kelvin by adjusting the LED drive currents. Subsequently the LED cluster was de-energized and placed in an environmental chamber for cooling the PCB and attached heat sink to −10° C. The LED cluster was then energized and chromaticity measurements were performed as the temperature of the heat sink stabilized. The respective CCTs and CCT deviations at each temperature are shown in Table 4. In this table, the “CCT Δuv” values represent the deviation from 3000 K along the blackbody locus (corresponding to the measured CCT), while the “3000 K Δuv” values represent the deviation both along and off the blackbody locus.

TABLE 4
Chromaticity fluctuations of example LED
cluster set at nominal 3000 K

| PCB Temperature | | | |
|---|---|---|---|
| (° C.) | CCT (K) | CCT Δuv | 3000 K Δuv |
| 15 | 3060 | 0.0010 | 0.0025 |
| 17.5 | 3060 | 0.0005 | 0.0023 |
| 20 | 3050 | 0.0005 | 0.0020 |
| 22.5 | 3045 | 0.0004 | 0.0018 |
| 25 | 3037 | 0.0002 | 0.0014 |
| 27.5 | 3033 | 0.0001 | 0.0012 |
| 30 | 3030 | 0.0001 | 0.0011 |
| 32.5 | 3025 | 0.0000 | 0.0009 |
| 35 | 3023 | −0.0001 | 0.0009 |
| 37.5 | 3057 | 0.0002 | 0.0022 |
| 40 | 3011 | −0.0001 | 0.0005 |
| 42.5 | 3016 | −0.0002 | 0.0006 |
| 45 | 3011 | −0.0002 | 0.0005 |
| 47.5 | 3046 | 0.0002 | 0.0017 |
| 50 | 3010 | −0.0002 | 0.0005 |
| 52.5 | 3015 | −0.0001 | 0.0006 |
| 55 | 3016 | −0.0001 | 0.0007 |
| 57.5 | 3021 | −0.0002 | 0.0008 |
| 60 | 3023 | 0.0000 | 0.0008 |

In another test, the same light source was set at full intensity and 6500 Kelvin CCT, allowed to thermally stabilize and subsequently de-energized and cooled to −10° C. Again the LED cluster was energized and chromaticity measurements were performed as the temperature of the heat sink stabilized. The respective CCTs and CCT deviations at each temperature are shown in Table 5.

TABLE 5
Chromaticity fluctuations of example LED
cluster set at nominal 6500 K

| PCB Temperature | | | |
|---|---|---|---|
| (° C.) | CCT (K) | CCT Δuv | 6500 K Δuv |
| 15 | 6762 | 0.0025 | 0.0034 |
| 17.5 | 6693 | 0.0017 | 0.0024 |
| 20 | 6657 | 0.0014 | 0.0020 |
| 22.5 | 6641 | 0.0012 | 0.0018 |
| 25 | 6612 | 0.001 | 0.0014 |
| 27.5 | 6584 | 0.0007 | 0.0010 |
| 30 | 6567 | 0.0005 | 0.0008 |
| 32.5 | 6547 | 0.0003 | 0.0005 |
| 35 | 6557 | 0.0003 | 0.0006 |
| 37.5 | 6542 | 0.0000 | 0.0005 |
| 40 | 6529 | −0.0001 | 0.0003 |
| 42.5 | 6526 | −0.0002 | 0.0004 |
| 45 | 6512 | −0.0003 | 0.0005 |
| 47.5 | 6496 | −0.0005 | 0.0005 |
| 50 | 6498 | −0.0006 | 0.0006 |
| 52.5 | 6488 | −0.0006 | 0.0007 |
| 55 | 6484 | −0.0006 | 0.0006 |
| 57.5 | 6493 | −0.0006 | 0.0006 |
| 60 | 6491 | −0.0005 | 0.0005 |

As illustrated in Tables 4 and 5, the tested embodiment of the light source according to the present invention maintained the LED cluster white light chromaticity to within about Δuv≈0.003 over a range of about 15° C. to 60° C. operating temperature. This is well within the ANSI and IEC chromaticity limits for white light lamps of Δuv=±0.003 (ANSLG, ANSI C78.376-2001, American National Standards Lighting Group, National Electrical Manufacturers Association, Rosslyn, Va., 2001).

In another of the performance of the light source configured as defined above, luminous flux output of the LED cluster was dimmed down to 10 percent intensity after thermal stabilization at full intensity with the CCT set to 3000 Kelvin. The results of this test are shown in Table 6.

TABLE 6
Chromaticity of LED cluster over dimming at 3000 K
using thermal feedback

| | PCB Temperature | CCT | | Deviation from Target |
|---|---|---|---|---|
| Intensity | (° C.) | (K) | Δuv | (Δuv) |
| 100% | 31.9 | 3035 | 0.0001 | 0.0013 |
| 90% | 31.2 | 3045 | 0.0005 | 0.0018 |
| 80% | 30.3 | 3056 | 0.0009 | 0.0023 |
| 70% | 29.3 | 3072 | 0.0011 | 0.0029 |
| 60% | 28.2 | 3086 | 0.0015 | 0.0035 |
| 50% | 27.2 | 3104 | 0.0019 | 0.0043 |
| 40% | 26.2 | 3125 | 0.0025 | 0.0052 |
| 30% | 25.2 | 3155 | 0.0032 | 0.0065 |
| 20% | 24.2 | 3192 | 0.0042 | 0.0082 |
| 10% | 23.2 | 3265 | 0.0063 | 0.0114 |

As shown in Table 6, the controller maintained the LED cluster white light chromaticity to within about Δuv≈0.01 over a dimming range of about 10:1. While this may exceed the ANSI and IEC chromaticity limits for white light lamps, it is noted that these limits apply to lamps operated at full power and 25° Celsius ambient temperature. As would be known to a worker skilled in the art, over their range of operating temperatures and during dimming fluorescent lamp chromaticities vary greater than that identified by the above test of a light source according to an embodiment of the present invention. The known variations of the operational characteristics of fluorescent lamps can be found for example in IESNA, The IESNA Lighting Handbook: Reference & Application, Ninth Edition, Illuminating Engineering Society of North America, New York, YK, 2000, for example FIG. 6-45.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

We claim:

1. A light source for generating a desired colour of light, said light source comprising:
a) one or more first light-emitting elements for generating first light having a first wavelength range, the one or more first light-emitting elements responsive to a first control signal;
b) one or more second light-emitting elements for generating second light having a second wavelength range, the one or more second light-emitting elements responsive to a second control signal;
c) one or more sensing devices for generating one or more signals representative of operating temperatures of the one or more first light-emitting elements and the one or more second light-emitting elements; and
d) a control system operatively coupled to the one or more first light-emitting elements, the one or more second light-emitting elements and the one or more sensing devices, the control system configured to receive the one or more signals and configured to determine the first control signal and the second control signal based upon the operating temperatures and the desired colour of light;
wherein the first light and the second light are blended to create the desired colour of light.

2. The light source according to claim 1, wherein the control system is preconfigured with one or more spectral radiant intensity models for predicting light colour based on operating temperature.

3. The light source according to claim 2, wherein at least one of the one or more spectral radiant intensity models includes one or more temperature dependent parameters.

4. The light source according to claim 2, wherein at least one of the one or more spectral radiant intensity models includes one or more Gaussian approximations.

5. The light source according to claim 3, wherein at least one of the temperature dependent parameters depends linearly on temperature.

6. The light source according to claim 3, wherein at least one of the temperature dependent parameters depends exponentially on temperature.

7. The light source according to claim 3, wherein the one or more temperature dependent parameters can be determined in a calibration procedure.

8. The light source according to claim 1, wherein the control system is preconfigured with a thermal model for predicting operating temperatures of one or more of the first light-emitting elements, or one or more of the second light-emitting elements or both.

9. The light source according to claim 8, wherein the thermal model depends at least on the first control signal.

10. The light source according to claim 8, wherein the thermal model depends at least on the second control signal.

11. The light source according to claim 8, wherein the control system is preconfigured with a thermal model for predicting slug temperatures of the first light-emitting elements or the second light-emitting elements or both.

12. The light source according to claim 8, wherein the control system is preconfigured with a thermal model for predicting junction temperatures of the one or more first light-emitting elements or the one or more second light-emitting elements or both.

13. The light source according to claim 1, wherein the first control signal is a pulse width modulated signal having a controllable first duty factor.

14. The light source according to claim 1, wherein the first control signal is a pulse code modulated signal having a controllable first duty factor.

15. The light source according to claim 1, wherein the second control signal is a pulse width modulated signal having a controllable second duty factor.

16. The light source according to claim 1, wherein the second control signal is a pulse code modulated signal having a controllable second duty factor.

17. The light source according to claim 1, wherein the control system is preconfigured to compensate for non-linear dependencies between the first duty factor and intensity of the first light.

18. The light source according to claim 1, wherein the control system is preconfigured to compensate for non-linear dependencies between the second duty factor and the intensity of the second light.

19. The light source according to claim 1, wherein the one or more sensing devices includes one or more temperature sensors.

20. The light source according to claim 1, wherein the one or more sensing devices includes one or more forward voltage sensors for sensing forward voltage of one or more of the first light-emitting elements.

21. The light source according to claim 1, wherein the one or more sensing devices includes one or more forward voltage sensors for sensing forward voltage of one or more of the second light-emitting elements.

22. A method for generating a desired colour of light, the method comprising the steps of:
a) determining a first operating temperature of one or more first light-emitting elements which provide first light having a first spectrum;
b) determining a second operating temperature of one or more second light-emitting elements which provide second light having a second spectrum;
c) providing a first spectral radiant intensity model indicative of effects of the first operating temperature on the first spectrum;
d) providing a second spectral radiant intensity model indicative of effects of the second operating temperature on the second spectrum;
e) determining a first control signal and a second control signal based upon the first spectral radiant intensity model, the second spectral radiant intensity model, the desired colour of light and the first operating temperature and second operating temperature;
f) providing the first control signal to the one or more first light-emitting elements;
g) providing the second control signal to the one or more second light-emitting elements; and
h) blending the first light and the second light into mixed light having the desired colour of light.

23. The method according to claim 22, wherein at least one of the first spectral radiant intensity model and the second spectral radiant intensity model include one or more Gaussian approximations.

24. The method according to claim 22, wherein the first operating temperature and the second operating temperature are slug temperatures.

25. The method according to claim 22, wherein the first operating temperature and the second operating temperature are junction temperatures.

26. The method according to claim 22, wherein the first control signal is a pulse-width modulated signal having a controllable first duty factor.

27. The method according to claim 22, wherein the first control signal is a pulse-code modulated signal having a controllable first duty factor.

28. The method according to claim 22, wherein the second control signal is a pulse-width modulated signal having a controllable second duty factor.

29. The method according to claim 22, wherein the second control signal is a pulse-code modulated signal having a controllable second duty factor.

30. The method according to claim 22, further comprising the step of providing a thermal model for predicting the first operating temperature and second operating temperature based on the first control signal and second control signal.

31. The method according to claim 30, wherein the thermal model includes non-linear dependencies between the first operating temperature and second operating temperature and the first control signal and the second control signal.
